(19) United States
(12) Patent Application Publication
(10) Pub. No.: US 2008/0247916 A1
(43) Pub. Date: Oct. 9, 2008

(54) REACTION APPARATUS AND REACTION CHIP

(75) Inventors: Toru Inaba, Tokyo (JP); Yasuhiko Sasaki, Tsuchiura (JP); Hiroshi Kishida, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Software Engineering Co., Ltd.

(21) Appl. No.: 12/099,181

(22) Filed: Apr. 8, 2008

(30) Foreign Application Priority Data
Apr. 9, 2007 (JP) 2007-101820

(51) Int. Cl. G05D 9/00; B01J 19/00

(52) U.S. Cl. 422/106; 422/198

(57) ABSTRACT

A reaction apparatus is provided with a reaction chip (50) for setting plural temperature regions and including a reaction channel (59) formed over these temperature regions, a pump for supplying a reaction liquid to a reaction channel of the reaction chip (50), a control device for controlling supply of the reaction liquid, and a heater for heating each of the temperature regions of the reaction chip (50) to the preset temperature. The reaction chip (50) is provided with a vacuum shielding layer (62) at the boundaries for separating each of the temperature regions. Accordingly, the reaction apparatus assures uniform and stable reaction within a short period of time.

### CLAIM OF PRIORITY

The present application claims priority from Japanese application JP 2007-101820 field on Apr. 9, 2007, the content of which is hereby incorporated by reference into this application.

### BACKGROUND OF THE INVENTION

1. Field of the Invention

The present invention relates to a reaction apparatus and a reaction chip and particularly to a PCR reaction apparatus utilizing PCR (Polymerase Chain Reaction) that can amplify nucleic acid such as DNA (Deoxyribonucleic acid) and RNA (Ribonucleic acid) and a reaction chip thereof.

2. Description of the Related Art

In these years, a DNA chip used for DNA analysis has been used widely in the various fields of medical treatment, foods inspection and dangerous objects inspection. This DNA chip is formed by fixing many single-stranded DNAs on a solid-phase. In order to conduct base arrangement analysis and diagnostic analysis using this DNA chip, only a small amount of nucleic acid such as DNA and RNA, or the like must be amplified up to the quantity required for analysis.

A PCR method has been proposed as a method for amplifying the nucleic acid. According to this PCR method, the particular target DNA, for example, can be amplified up to 100,000 times or more. DNA is configured with longer double-stranded molecules coupled with four kinds bases (A: adenine, G: guanine, C: cytosine, and T: thymine), forming a pair with adenine A of one strand and thymine T of the other strand and a pair with guanine G of one strand and cytosine C of the other strand. DNA has the characteristic that coupled strands are decoupled into individual single strands when temperature rises (for example, up to 94° C.), while the coupled strands are recovered again when temperature is lowered again. When a large amount primer (a set of single-stranded DNAs having the base arrangement equivalent to several bases at both ends of the target DNA region) is introduced, for example, at 55° C. when the coupled strands are decoupled into individual strands, these strands are coupled with priority to a region of the complementary arrangement on the respective strands. If the DNA synthetase (DNA polymerase) and four kinds of bases, for example, exist there under 72° C., the strands are respectively synthesized from the starting point of the part coupled with the primer. With use of this DNA polymerase, continuous reaction of the DNA synthesis is driven to increase DNA only by repeating the rise and fall cycle of temperature (94° C.→55° C.→72° C.→94° C.).

Recently, experiment for amplification of nucleic acid is often conducted using a small-sized chip provided with a reaction channel.

For example, as described in “Sensors and Actuators B 105 (2005) 251-258”, investigation is continued for a method to realize amplified reaction of nucleic acid by heating and cooling a PCR reaction chip as a reaction vessel in order to raise or fall the temperature of the reaction liquid as a whole.

Meanwhile, as JP-A-2005-253466 describes, investigation is also continued for a method to amplify nucleic acid by forming a channel for different temperature regions within the PCR reaction chip and then allowing the reaction liquid to flow into this channel in order to raise or fall the temperature of the reaction liquid.

However, the method of “Sensors and Actuators B 105 (2005) 251-258” described above has the problems that since the PCR reaction chip as a whole is heated and cooled, a longer time is required until the PCR reaction is completed by repeating heat treatments and cooling treatments and therefore a longer time is also required for amplification of nucleic acid.

Moreover, the method of JP-A-2005-253466 described above has a merit that a reaction time can be shortened in comparison with the time in “Sensors and Actuators B 105 (2005) 251-258”, because temperature is not changed by heating the entire part of the PCR reaction chip, different temperature regions are set within the chip, a channel is formed in the respective regions, and temperature of the reaction liquid is varied by allowing the reaction liquid to flow into the channel. However, although the PCR chip is produced by a resin such as PDMS (Polydimethylsiloxane: (C₂H₆SiO)ₙ) in order to control increase in manufacturing cost, thermal conductivity of PDMS is as low as about 0.2[W/mK] and is as small as 1/1000 in comparison with that of a metal material. Moreover, the difference between the ambient temperature and the setting temperature is large. Therefore, a temperature difference is also generated within the PCR reaction chip, even when the PCR reaction chip is heated from the lower surface. As a result, the temperature at each region of the reaction liquid does not become uniform, and failure of the predetermined PCR reaction has been feared.

### SUMMARY OF THE INVENTION

An object of the present invention is to provide a reaction apparatus and a reaction chip for implementing uniform and stable reaction of a reaction liquid within a short period of time.

According to a first aspect of the present invention in order to achieve the object explained above, a reaction apparatus is provided with a heat insulating air layer at the boundary dividing plural temperature regions of the reaction chip, in addition to a reaction chip including the temperature regions and a resin reaction channel formed over these temperature regions, a pump for supplying a reaction liquid to the reaction channel of the reaction chip, a control device for controlling supply of the reaction liquid, and a heater for heating each of the temperature regions of the reaction chip to the preset temperature.

Examples of structure as more preferable embodiments in the first aspect of the present invention are as follows.
(1) A meander reaction channel at each of the temperature regions of the reaction chip is provided on a heated surface side of the reaction chip and each meander reaction channel is communicated with a channel detouring the heat insulating air layer on a non-heated surface side.
(2) The heat insulating air layer is constituted with formation of a concave groove in on heated surface side of the reaction chip.
(3) A high heat conductivity member having a conductivity higher than that of the reaction chip is provided surrounding each of the temperature regions of the reaction chip.
(4) The high heat conductivity member is provided on a reaction stage.
(5) The high heat conductivity member is constituted in common with the reaction stage.
(6) The control device controls supply of the reaction liquid to realize reciprocated supply thereof for reaction of the reaction liquid in the reaction channel of each of the temperature regions of the reaction chip.
(7) Concave and convex shapes are provided on the side surface of the reaction region in each of the temperature regions of the reaction chip.

Moreover, according to a second aspect of the present invention, the resin reaction chip where the plural temperature regions heated with the heater are set and the reaction channel is formed over these temperature regions is provided with the heat insulating air layer extending to the boundary of the temperature regions.

Moreover, according to a third aspect of the present invention, the reaction apparatus is further provided with the high heat conductivity member having the heat conductivity higher than that of the reaction chip surrounding each of the temperature regions of the reaction chip, in addition to the reaction chip formed of the resin material where the plural temperature regions are set and the reaction channel is formed over these temperature regions, the pump for supplying the reaction liquid to the reaction channel of the reaction chip, the control device for controlling supply of the reaction liquid, and the heater for heating each of the temperature regions of the reaction chip to the preset temperature.

Moreover, according to a fourth aspect of the present invention, the reaction apparatus is provided with the resin reaction chip where the plural temperature regions are set and the reaction channel formed over these temperature regions, the pump for supplying the reaction liquid to the reaction channel of the reaction chip, the control device for controlling supply of the reaction liquid, and the heater for heating each of the temperature regions of the reaction chip to the preset temperature, wherein the control device controls the reaction liquid to realize reciprocating supply of the reaction liquid to implement reciprocated supply thereof for reaction of the reaction liquid in the reaction channel of each of the temperature regions of the reaction chip.

According to the reaction apparatus and the reaction chip of the present invention explained above, reaction of the reaction liquid can be realized uniformly and stably within a short period of time.

### BRIEF DESCRIPTION OF THE DRAWINGS

FIG. 1 is a perspective view of a PCR reaction apparatus of a preferred embodiment of the present invention;

FIG. 2 is a plan view for explaining a reaction channel of a reaction chip of FIG. 1;

FIG. 3A is a perspective view of the reaction chip of FIG. 1;

FIG. 3B is a cross-sectional view taken along the arrows A-A of FIG. 3A;

FIG. 4 is a perspective view showing an assembled state of the reaction chip and a high heat conductivity member of FIG. 1;

FIG. 5A is a perspective view of the state where the reaction chip of FIG. 1 is assembled with reaction stages;

FIG. 5B is a perspective view of the condition where the reaction chip of FIG. 5A is eliminated; and

FIG. 6 is a comparison diagram for temperature distribution in the reaction chip of the preferred embodiment and a comparison example.

### DETAILED DESCRIPTION OF THE PREFERRED EMBODIMENT

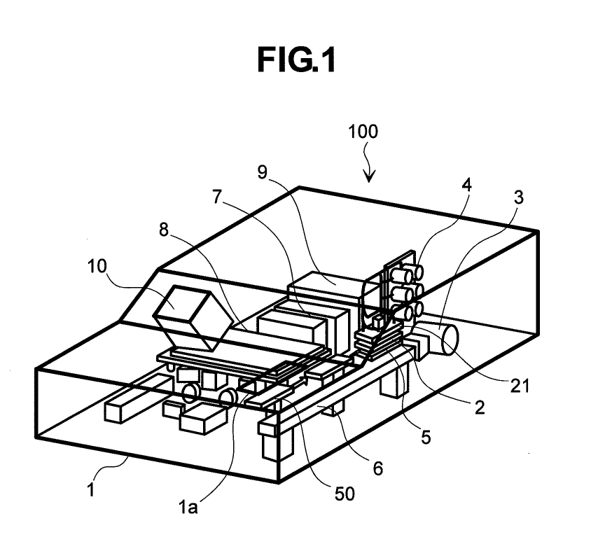

A preferred embodiment of a reaction apparatus of the present invention will be explained with reference to FIG. 1 to FIG. 6. A PCR reaction apparatus for amplifying DNA is taken into account as an example of the reaction apparatus of this preferred embodiment. However, the present invention may be applied also to the PCR reaction apparatus for amplifying RNA. Moreover, the present invention may also be applied to a biochemical reaction apparatus which requires uniformity in plural temperature regions provided within a reaction chip.

First, a general structure of a PCR reaction apparatus 100 of the preferred embodiment will be explained with reference to FIG. 1.

The PCR reaction apparatus 100 for amplifying nucleic acid is constituted with a reaction chip 50, a reaction stage 2, a pump 3, a valve 4, a heater 5, a moving stage 6, a motor driver 7, a control substrate 8, a power supply 9, an information access panel 10, the other components, and a case 1 for accommodating these elements in an internal space.

The case 1 has a chip inserting window 1a for inserting the reaction chip 50 at a front part of an upper surface thereof. The moving stage 6 is provided extending backward from the lower position of the chip inserting window 1a. The reaction stage 2 can move with the moving stage 6. The reaction chip 50 is inserted into the case 1 through the chip inserting window 1a and is then moved up to the reaction position together with the reaction stage 2 while it is placed on the reaction stage 2. At this reaction position, the chip is clamped and fixed with a chip clamper 21. Thereafter, a reaction liquid is supplied through this chip damper 21.

The heater 5 is integrally placed at the lower part of the reaction stage 2 to heat the reaction chip 50. As the heater 5, a carbon heater held with insulating sheets such as polyimide films is used and heating temperature of the heater itself is equalized by covering the upper surface of the heater 5 with a heat radiating sheet. This heater 5 is installed in the number that is equal to the number of temperature regions to be set.

The pump 3 is provided to transfer a DNA sample liquid and a cleaning liquid to the reaction chip 50 and a syringe pump is used as the pump 3. The valve 4 is provided in a transfer route of the pump 3 to select transfer of the DNA sample liquid and the cleaning liquid. The pump 3 and valve 4 constitute a liquid transfer device for transferring the DNA sample liquid and the cleaning liquid.

The motor driver 7 and control substrate 8 constitute the control device to control the moving stage 6, pump 3, valve 4 and heater 5 or the like. The power supply 9 supplies electrical powers to various components. The information access panel 10 is provided to input measuring conditions. Supply of liquid is controlled on the basis of the result of detection through visualization of the interface between the air and liquid surface with a camera.

The reaction chip 50 is inserted into the case 1 through the chip inserting window 1a and is then moved up to the reaction position together with the movable reaction stage 2. The DNA sample liquid and the cleaning liquid are supplied through reciprocated supply into the reaction channel of the reaction chip 50 with switching operation of pressurization with the syringe pump 3 and supply of liquid with the valve 4. The control device formed of the motor driver 7 and the control substrate 8 controls movement of the reaction chip 50 and reciprocated supply of the DNA sample liquid and the cleaning liquid based on the measuring conditions inputted from the information access panel 10.

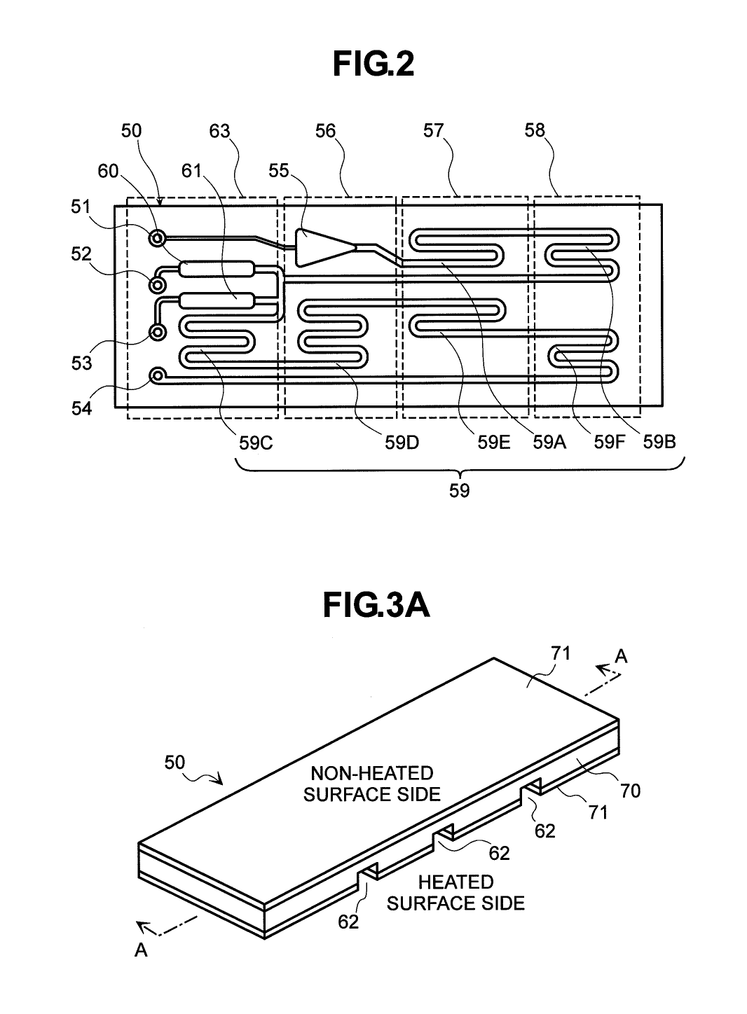

Next, the reaction chip 50 will be explained concretely by referring to FIG. 2 to FIG. 5B.

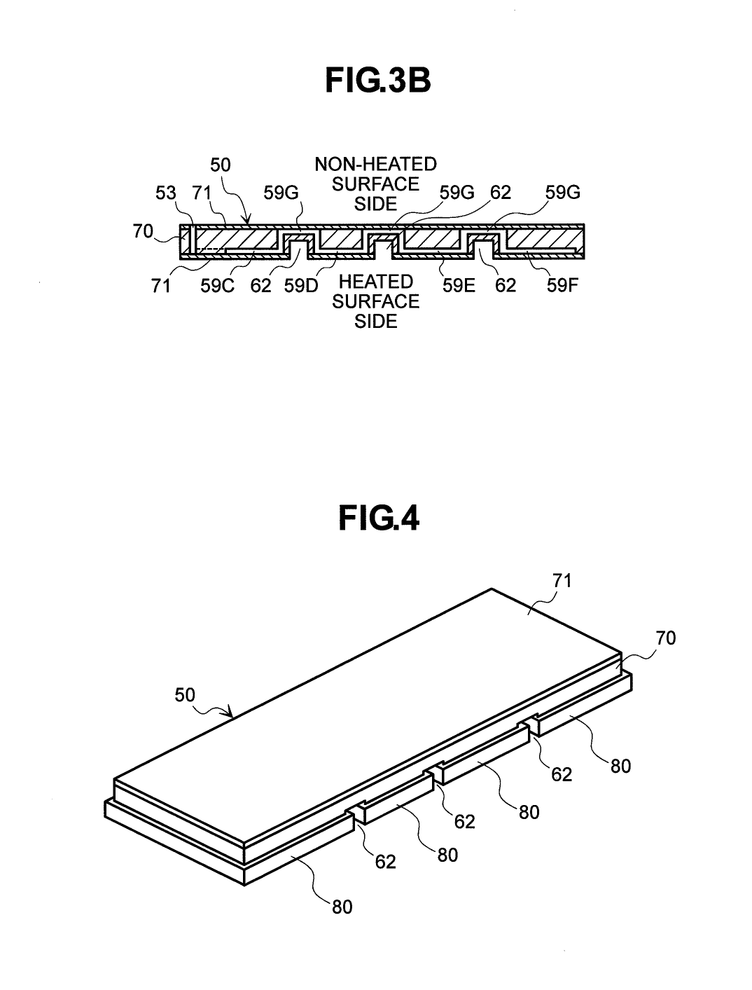

FIG. 2 is a plan view for explaining the reaction channel of the reaction chip of FIG. 1. FIG. 3A is a perspective view of the reaction chip of FIG. 1. FIG. 3B is a cross-sectional view along the arrows A-A of FIG. 3A. The reaction chip 50 is constituted with a microchip as a vessel for PCR reaction and is manufactured with a resin material such as PDMS for reduction of manufacturing cost. In this embodiment, this reaction chip 50 is formed of a chip body 70 constituted with a PDMS plate in the height of about 5 mm used to form a reaction channel 59 or the like and a body cover 71 constituted with a PDMS plate in the height of about 1 mm used to close the reaction channel 59 or the like. The body cover 71 is joined to both upper and lower surfaces of the chip body 70 to form the channel in combination with the chip body 70. Accordingly, the reaction chip 50 can be easily manufactured in lower price.

This reaction chip 50 is divided into an ambient temperature region 63 and plural temperature regions (three temperature regions in this embodiment) 56 to 58 for the PCR reaction. These three regions are constituted with a 55-to-60° C. region (first temperature region) indicated by a broken line 56, a 72° C. region (second temperature region) indicated by a broken line 57, and a 94° C. region (third temperature region) indicated by a broken line 58 and respectively heated with three heaters 5.

The ambient temperature region 63 is provided with plural handling ports 51, 52, 53, and 54 for injecting and extracting a reagent liquid and the cleaning liquid and plural vessels 60, 61. The vessel 60 stores a liquid (for example, PCR mixture) supplied through the handling port 52. The vessel 61 stores a liquid (for example, primer) supplied through the handling port 53. The first region 56 is provided with a DNA extracting liquid reservoir 55 for collecting the cells for extraction of DNA. The reaction channel 59 is formed over the regions 56 to 58, and 63. The DNA extracting liquid is supplied to the DNA extracting liquid reservoir 55 via the handling port 51. The reaction channel 59 is formed as the meander channel. Reaction can be accelerated with reciprocated supply of the DNA sample liquid (reaction liquid) for the reaction within the reaction channel 59 of each temperature region.

Protocol of the reaction chip 50 can be divided into a couple of steps of DNA extraction and PCR process. An example of the reaction protocol for implementing the PCR reaction using the reaction chip 50 will be explained below. Here, it is assumed that DNA has been extracted from a mucous membrane within the mouth.

First, a brush having scrubbed the mucous membrane in the mouth is soaked into the DNA extracting liquid stored in the DNA extracting liquid reservoir 55. Next, the DNA extracting liquid is supplied to the 94° C. region 58 through the 72° C. region 57 and this liquid is incubated to a high temperature, while the liquid is supplied with the reciprocating supply method in the meander channel 59B, in order to extract DNA.

Next, the PCR process is conducted. The incubated liquid of several mL is sampled and this sampled liquid is combined with two kinds of PCR mixture stored in the vessel 60 and primer stored in the vessel 61 in the meander channel 59C and these liquids are mixed through the reciprocating supply within the meander channel 59C provided in the ambient temperature region 63. Thereafter, the mixed liquid is sequentially supplied to the 55 to 60° C. region 56, 72° C. region 57, and 94° C. region 58. A temperature cycle is executed by repeating this reciprocating supply of the mixed liquid in the respective temperature regions to amplify DNA. Finally, the amplified DNA is extracted from an extracting port 54.

In this embodiment, three kinds of temperature regions of 55-to-60° C. region 56, 72° C. region 57, and 94° C. region 58 are provided, but the number of temperature regions can be set to 2 or more as required. The present invention is effective to the chip required to include different temperature regions.

In view of attaining uniform temperature of the reaction liquid in the temperature regions 56 to 58, a heat insulating air layer is provided at the boundaries to separate the temperature regions 56-to-58 of the reaction chip 50. As this heat insulating air layer, the most simplified and effective heat insulating air layer 6 is formed. This heat insulating air layer 62 can be obtained in the more simplified structure configured by forming a concave groove in the heated surface side of the reaction chip 50.

In this embodiment, the meander reaction channels 59A to 59F in the temperature regions 56 to 58, and 63 of the reaction chip 50 are provided in the heated surface side of the reaction chip 50 and the meander reaction channels 59A to 59F are communicated with each other through the liquid supply channel 59G detouring the heat insulating air layer 62 in the non-heated surface side. Accordingly, uniformity of temperature at the temperature regions 56 to 58, and 63 can be further improved.

As shown in FIG. 4, each of the temperature regions 56 to 58, 63 is surrounded with a ring-shaped high heat conductivity member 80 having heat conductivity higher than that of the reaction chip 50. Therefore, thermal influence from the ambient of the temperature regions 56 to 58, 63 can be equalized and thereby uniformity of temperature in the temperature regions 56 to 58, 63 can be realized.

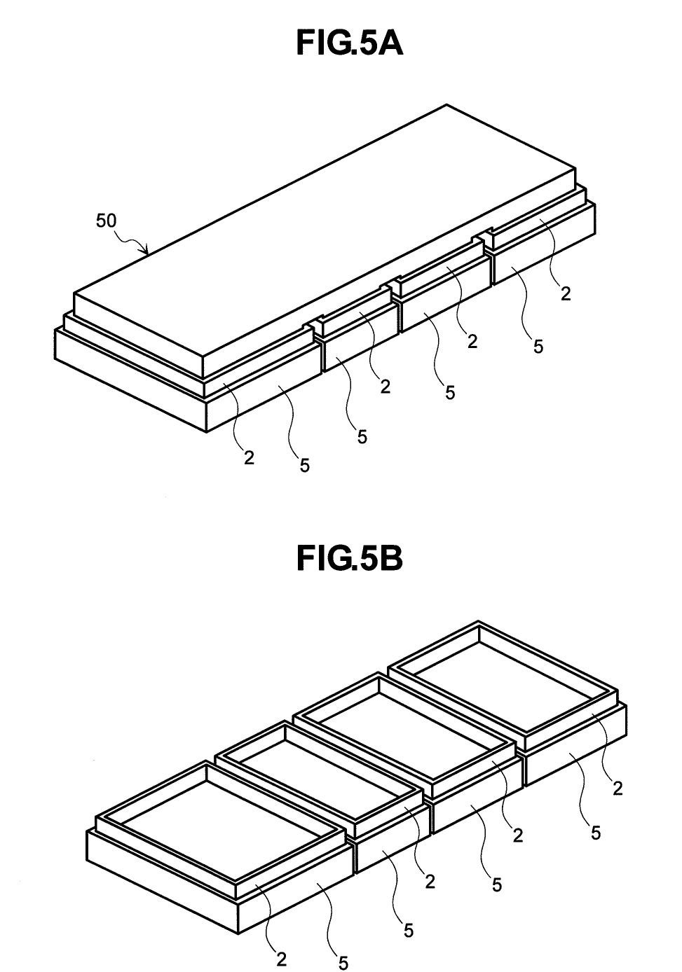

As shown in FIG. 5A and FIG. 5B, the reaction stage 2 in the apparatus side is formed of the same material in the same shape as the ring-shaped high heat conductivity member 80 and the reaction chip 50 is provided near the heater 5 and the high heat conductivity member 80 is constituted in common use with the reaction. In this case, uniformity of temperature in the temperature regions 56 to 58, 63 can be further improved.

In this embodiment, the meander channels 59A to 59F of the temperature regions 56 to 58, 63 includes many turning points having a large radius of curvature in order to accelerate reaction and mixture in the temperature regions 56 to 58, 63. Such turning points generate flow of reaction liquid accompanied by the secondary flow. Accordingly, three-dimensional flow occurs in the meander reaction channels 59A to 59F. Moreover, flow of the reaction liquid is disturbed, mixture of the reaction liquids is further accelerated, and thereby reaction time can be shortened by providing concave and convex areas at the side surface of the meander reaction channels 59A to 59F.

In the case where the reaction liquid is supplied to the temperature regions 56 to 58, 63 for reaction, it is often observed as a problem to be solved that the reaction liquid is destroyed at the boundary of air and is then disassembled into plural liquids. However, destruction of reaction liquid itself can be prevented with the surface tension of the reaction liquid and disassembling the reaction liquid into two kinds of liquids can also be prevented by introducing the meander reaction channels 59A to 59F and realizing reciprocating supply of the reaction liquid.

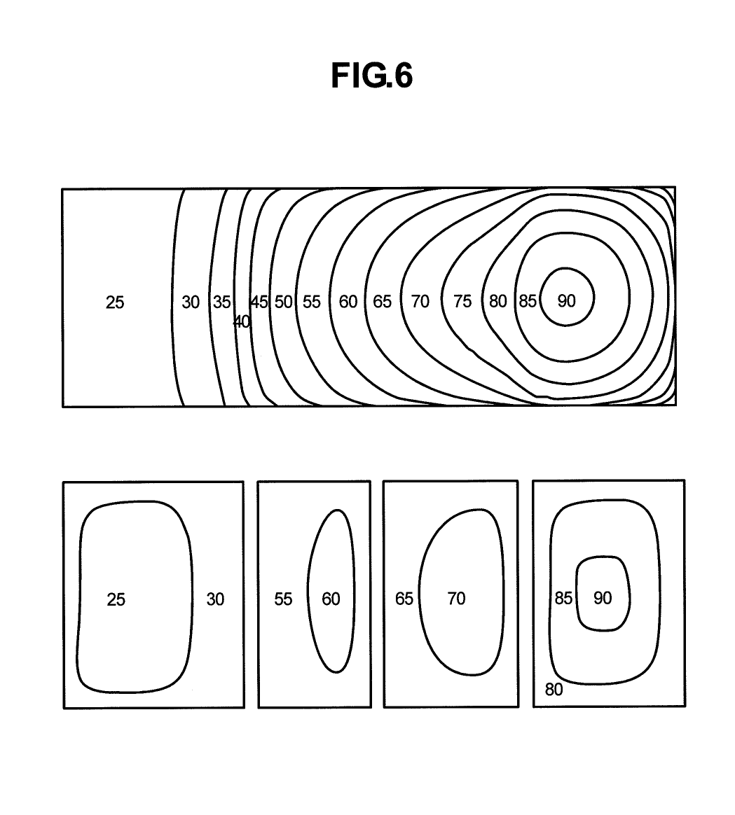

In order to search the effectiveness of the present invention, thermal-fluid analysis has been implemented to the reaction chip 50 used in this embodiment and the reaction chip as a comparison example not including the heat insulating air layer 62. FIG. 6 shows a result of comparison of temperature distribution in the heated surface side. Numerals given in the figure indicate temperature. The upper figure shows temperature distribution in the heated surface side for the reaction chip as the comparison example. This upper figure suggests that a large temperature distribution appears, even when the three temperature regions are respectively heated with the heater. The lower figure shows a large temperature distribution in the heated surface side for the reaction chip 50 used in this embodiment. This lower figure suggests that almost uniform temperature distribution appears in each temperature region. From the results explained above, it is understood that the structure of the present embodiment can realize uniform temperature region and execute uniform and stable PCR reaction while the reaction rate can be shortened.

According to this embodiment, as explained above, each temperature region in the reaction chip can be set to the predetermined equivalent temperature. Therefore, nucleic acid can be stably amplified with the PCR method. Moreover, the reaction chip itself can be reduced in size, because uniform region may substantially be increased.

In addition, since the reaction chip may be manufactured with a resin material such as PDMS, it may be utilized as a disposable chip. Further, the reaction chip has a higher degree of freedom in the shape of reaction channel because it is required to set plural temperature regions. However, since the reaction chip itself can be manufactured with a resin material such as PDMS, the reaction channel can be designed easily.

Since the reaction channel is formed as the meander channel, three-dimensional flow caused by secondary flow at the turning points can accelerate reaction. Moreover, since the reaction liquid is supplied not only in the single direction but also in the reciprocating supply method, reaction efficiency can be improved and channel length can also be shortened. In addition, since the reaction channel is not constituted in a rectangular channel but constituted as the channel provided with projected areas on the surface of channel, reaction amount can be increased more effectively. Therefore, a small-sized and highly efficient PCR reaction apparatus can be obtained.

What is claimed is:

1. A reaction apparatus, comprising:
a resin reaction chip including a plurality of temperature regions and a reaction channel formed over these temperature regions;
a pump for supplying a reaction liquid to the reaction channel of the reaction chip;
a control device for controlling supply of the reaction liquid; and
a heater for heating each of the temperature regions of the reaction chip to a preset temperature,
wherein a heat insulating air layer is provided to boundaries to separate each of the temperature regions of the reaction chip.

2. The reaction apparatus according to claim 1, wherein a meander channel in each of the temperature regions of the reaction chip is provided on a heated surface side of the reaction chip and each meander reaction channel is communicated with a channel detouring the heat insulating air layer on a non-heated surface side.

3. The reaction apparatus according to claim 2, wherein the heat insulating air layer is constituted by forming a concave groove on the heated surface side of the reaction chip.

4. The reaction apparatus according to claim 1, wherein a high heat conductivity member having a heat conductivity higher than that of the reaction chip is provided surrounding each of the temperature regions of the reaction chip.

5. The reaction apparatus according to claim 4, wherein the high heat conductivity member is provided on a reaction stage.

6. The reaction apparatus according to claim 4, wherein the high heat conductivity member is constituted in common use with the reaction stage.

7. The reaction apparatus according to claim 1, wherein the control device controls the reaction liquid to realize reciprocating supply for reaction of the reaction liquid in the reaction channel of each of the temperature regions of the reaction chip.

8. The reaction apparatus according to claim 1, wherein concave and convex shapes are provided in a side surface of the reaction channel in each of the temperature regions of the reaction chip.

9. A resin reaction chip setting a plurality of temperature regions heated with a heater and including a reaction channel formed over these temperature regions, wherein a heat insulating air layer is formed extending to the boundaries of the temperature regions.

10. A reaction apparatus, comprising:
a resin reaction chip including a plurality of temperature regions and including a reaction channel formed over these temperature regions;
a pump for supplying a reaction liquid to the reaction channel of the reaction chip;
a control device for controlling supply of the reaction liquid; and
a heater for heating each of the temperature regions of the reaction chip to the preset temperature,
wherein a high heat conductivity member having a heat conductivity higher than that of the reaction chip is provided surrounding each of the temperature regions of the reaction chip.

11. A reaction apparatus, comprising:
a resin reaction chip including a plurality of temperature regions and including a reaction channel formed over these temperature regions;
a pump for supplying a reaction liquid to the reaction channel of the reaction chip;
a control device for controlling supply of the reaction liquid; and
a heater for heating each of the temperature regions of the reaction chip to the preset temperature,
wherein the control device controls the reaction liquid to realize reciprocating supply for reaction of the reaction liquid in the reaction channel of each of the temperature regions of the reaction chip.
